(19) United States
(12) Patent Application Publication
(10) Pub. No.: US 2019/0123323 A1
(43) Pub. Date: Apr. 25, 2019

(54) COMPOSITION

(71) Applicant: Sumitomo Chemical Company, Limited, Tokyo (JP)

(72) Inventor: Toshihiko OGATA, Osaka (JP)

(21) Appl. No.: 16/169,179

(22) Filed: Oct. 24, 2018

(30) Foreign Application Priority Data
Oct. 24, 2017 (JP) 2017-205597

(51) Int. Cl. H01M 2/16; H01M 10/0565; C08L 23/02; C08L 77/10

(52) U.S. Cl. CPC H01M 2/1653; H01M 10/0565; H01M 4/131; C08L 23/02; C08L 77/10; H01M 2/1666

(57) ABSTRACT

It is an object of the present invention to provide (i) a composition as a material of a nonaqueous electrolyte secondary battery porous layer having an excellent dimension retaining rate and excellent air permeability, (ii) a nonaqueous electrolyte secondary battery porous layer made of the composition, (iii) a nonaqueous electrolyte secondary battery separator including the nonaqueous electrolyte secondary battery porous layer, (iv) a nonaqueous electrolyte secondary battery member, and (v) a nonaqueous electrolyte secondary battery. The above object is attained by use of a composition containing an organic solvent and an aramid filler dispersed therein.

This Nonprovisional application claims priority under 35 U.S.C. § 119 on Patent Application No. 2017-205597 filed in Japan on Oct. 24, 2017, the entire contents of which are hereby incorporated by reference.

### TECHNICAL FIELD

The present invention relates to (i) a composition, (ii) a porous layer for a nonaqueous electrolyte secondary battery (hereinafter referred to as a “nonaqueous electrolyte secondary battery porous layer”), (iii) a separator for a nonaqueous electrolyte secondary battery (hereinafter referred to as a “nonaqueous electrolyte secondary battery separator”), (iv) a member for a nonaqueous electrolyte secondary battery (hereinafter referred to as a “nonaqueous electrolyte secondary battery member”), and (v) a nonaqueous electrolyte secondary battery.

### BACKGROUND ART

Nonaqueous electrolyte secondary batteries, particularly lithium ion secondary batteries, have a high energy density and are thus in wide use as batteries for personal computers, mobile telephones, portable information terminals, and the like. Such nonaqueous electrolyte secondary batteries have recently been developed as on-vehicle batteries.

As a member of a nonaqueous electrolyte secondary battery, separators having excellent heat resistance, for example, are being developed (see Patent Literature 1).

For example, Patent Literature 1 discloses a nonaqueous electrolyte secondary battery laminated separator which serves as a nonaqueous electrolyte secondary battery separator having excellent heat resistance and which is a laminated body including (i) a polyolefin porous film and (ii) a porous film that is provided on the polyolefin porous film and that contains an aramid resin which is a heat-resistant resin.

### CITATION LIST

### Patent Literature

[Patent Literature 1]

Japanese Patent Application Publication, Tokukai, No. 2001-23602 (Publication Date: January 26, 2001)

### SUMMARY OF INVENTION

### Technical Problem

The above-described conventional nonaqueous electrolyte secondary batteries including a porous layer made of aramid resin, unfortunately, leave room for improvement in terms of air permeability.

In view of that, it is an object of an aspect of the present invention to provide (i) a composition as a material of a nonaqueous electrolyte secondary battery porous layer having excellent air permeability, (ii) a nonaqueous electrolyte secondary battery porous layer made of the composition, (iii) a nonaqueous electrolyte secondary battery separator including the nonaqueous electrolyte secondary battery porous layer, (iv) a nonaqueous electrolyte secondary battery member, and (v) a nonaqueous electrolyte secondary battery.

### Solution to Problem

In order to attain the above object, a composition in accordance with an aspect of the present invention includes: an organic solvent; and an aramid filler dispersed in the organic solvent.

A composition in accordance with an aspect of the present invention is preferably arranged such that

a formula (1) below is satisfied, where a represents a viscosity [Pa·sec] that the composition has when the composition is sheared at a shear rate of 0.1 [sec⁻¹], and b represents a viscosity [Pa·sec] that the composition has when the composition is sheared at a shear rate of 100 [sec⁻¹].

1≤a/b≤150 (1)

A composition in accordance with an aspect of the present invention is preferably arranged such that a formula (2) below is satisfied, where a represents a viscosity [Pa·sec] that the composition has when the composition is sheared at a shear rate of 0.1 [sec⁻¹], and c represents a viscosity [Pa·sec] that the composition has when the composition is sheared at a shear rate of 10000 [sec⁻¹].

2≤a/c≤2000 (2)

A composition in accordance with an aspect of the present invention is preferably arranged such that a formula (3) below is preferably satisfied, where A represents a viscosity [Pa·sec] that the composition has with a shear rate being 0.1 [sec⁻¹] at a start of an increase of the shear rate in a case where the composition is sheared while the shear rate is being increased from 0.1 [sec⁻¹] to 10000 [sec⁻¹] and is then sheared while the shear rate is being decreased from 10000 [sec⁻¹] to 0.1 [sec⁻¹], and B represents a viscosity [Pa·sec] that the composition has with the shear rate being 0.1 [sec⁻¹] at an end of a decrease of the shear rate in the case.

0.01≤|A−B|≤200 (3)

In order to attain the above object, a nonaqueous electrolyte secondary battery porous layer in accordance with an aspect of the present invention includes a composition in accordance with an aspect of the present invention.

In order to attain the above object, a nonaqueous electrolyte secondary battery separator in accordance with an aspect of the present invention includes (i) a polyolefin porous film and (ii) a nonaqueous electrolyte secondary battery porous layer in accordance with an aspect of the present invention on one surface or both surfaces of the polyolefin porous film.

In order to attain the above object, a nonaqueous electrolyte secondary battery member in accordance with an aspect of the present invention includes (i) a positive electrode, (ii) a nonaqueous electrolyte secondary battery porous layer in accordance with an aspect of the present invention or a nonaqueous electrolyte secondary battery separator in accordance with an aspect of the present invention, and (iii) a negative electrode, the positive electrode, the nonaqueous electrolyte secondary battery porous layer or the nonaqueous electrolyte secondary battery separator, and the negative electrode being arranged in this order.

In order to attain the above object, a nonaqueous electrolyte secondary battery in accordance with an aspect of the present invention includes a nonaqueous electrolyte secondary battery porous layer in accordance with an aspect of the present invention or a nonaqueous electrolyte secondary battery separator in accordance with an aspect of the present invention.

### Advantageous Effects of Invention

An aspect of the present invention provides a composition as a material of a nonaqueous electrolyte secondary battery porous layer having excellent air permeability.

### DESCRIPTION OF EMBODIMENTS

The following description will discuss an aspect of the present invention. The present invention is, however, not limited to the arrangements described below, but may be altered in various ways by a skilled person within the scope of the claims. The present invention also encompasses in its technical scope any embodiment and example based on an appropriate combination of technical means disclosed in different embodiments and examples. All documents cited in the present specification are incorporated herein by reference. In the present specification, numerical ranges in the form of “A to B” mean “not less than A and not more than B”.

[1. Composition and Nonaqueous Electrolyte Secondary Battery Porous Layer]

The composition in accordance with an aspect of the present invention includes an organic solvent and an aramid filler dispersed in the organic solvent. The composition in accordance with an aspect of the present invention is usable as a coating material for preparing a nonaqueous electrolyte secondary battery porous layer, and may thus be regarded as a coating material or a nonaqueous electrolyte secondary battery coating material.

The degree of dispersion of the aramid filler in the composition is not limited to any particular one. The degree of dispersion is, for example, such that in a case where the composition in a container has been stirred and then let stand for 1 hour, not more than 10% by weight, preferably not more than 5% by weight, more preferably not more than 1% by weight, even more preferably not more than 0.1% by weight, most preferably not more than 0.01% by weight, of all the aramid filler in the composition precipitates on the bottom of the container.

The organic solvent is not limited to any particular one, but is preferably N-methylpyrrolidone, N,N-dimethylacetamide, N,N-dimethylformamide, or acetone to uniformly and stably disperse the aramid filler.

The content of the aramid filler in the composition is not limited to any particular value. The aramid filler is contained in an amount of preferably less than 50% by weight, more preferably less than 30% by weight, even more preferably less than 20% by weight, even more preferably less than 10% by weight, relative to the total weight of the composition for better dispersibility of the aramid filler. Further, the content of the aramid filler in the composition is preferably more than 0.5% by weight, more preferably more than 2% by weight, relative to the total weight of the composition for better productivity of a nonaqueous electrolyte secondary battery porous layer to be produced from the composition. The composition containing the aramid filler in an amount of less than 50% by weight prevents the aramid filler from agglomerating in the composition and easily allows the aramid filler to remain uniformly dispersed. The composition containing the aramid filler in an amount of more than 0.5% by weight allows the composition to be applied in a reduced amount relative to the weight per unit area of a nonaqueous electrolyte secondary battery porous layer to be produced from the composition, thereby shortening the coating and drying steps.

In the present specification, the term “aramid filler” refers to particles containing aramid resin as a main component. Further, in the present specification, expressions such as “containing aramid resin as a main component” mean that the particles contain aramid resin at a proportion of typically not less than 50% by volume, preferably not less than 90% by volume, more preferably not less than 95% by volume, relative to 100% by volume of the particles.

The component of the aramid filler (aramid resins such as aromatic polyamide and wholly aromatic polyamide) is not limited to any particular one, and may be, for example, para-aramid, meta-aramid, or a mixture thereof.

Examples of a method for preparing the para-aramid encompass, but are not particularly limited to, condensation polymerization of para-oriented aromatic diamine and para-oriented aromatic dicarboxylic acid halide. In such a case, para-aramid to be obtained substantially includes repeating units in which amide bonds are bonded at para positions or corresponding oriented positions (for example, oriented positions that extend coaxially or parallel in opposite directions such as the cases of 4,4′-biphenylene, 1,5-naphthalene, and 2,6-naphthalene) of aromatic rings. Specific examples of the para-aramid encompass para-aramids each having a para-oriented structure or a structure corresponding to a para-oriented structure, such as poly(paraphenylene terephthalamide), poly(parabenzamide), poly(4,4′-benzanilide terephthalamide), poly(paraphenylene-4,4′-biphenylene dicarboxylic acid amide), poly(paraphenylene-2,6-naphthalene dicarboxylic acid amide), poly(2-chloro-paraphenylene terephthalamide), and paraphenylene terephthalamide/2,6-dichloroparaphenylene terephthalamide copolymer.

Examples of a method for preparing the meta-aramid encompass, but are not limited to, (i) condensation polymerization of meta-oriented aromatic diamine and meta-oriented aromatic dicarboxylic acid halide or para-oriented aromatic dicarboxylic acid halide and (ii) condensation polymerization of meta-oriented aromatic diamine or para-oriented aromatic diamine and meta-oriented aromatic dicarboxylic acid halide. In such a case, meta-aramid to be obtained contains a repeating unit in which an amide is bonded to an aromatic ring at the meta position or another orientation position corresponding to the meta position. Specific examples of the meta-aramid encompass a metaphenylene terephthalamide/2,6-dichloroparaphenylene terephthalamide copolymer, poly(metaphenylene isophthalamide), poly(metabenzamide), poly(metaphenylene-4,4′-biphenylene dicarboxylic acid amide), and poly(metaphenylene-2,6-naphthalene dicarboxylic acid amide).

The composition in accordance with an embodiment of the present invention may be produced by dispersing the above aramid filler in an organic solvent. The method for dispersing the above aramid filler in an organic solvent is not limited to any particular one, but may be a method of precipitating aramid filler out of an aramid solution containing an organic solvent or a method of dispersing in an organic solvent an aramid filler prepared separately.

Assuming that the aramid filler is poly(paraphenylene terephthalamide) (hereinafter referred to as “PPTA”), examples of the method for preparing the composition in accordance with an embodiment of the present invention include a method including the following steps (1) to (5):

(1) N-methyl-2-pyrrolidone (hereinafter also referred to as “NMP”) is introduced as an organic solvent into a flask which is dried. Then, calcium chloride, which has been dried at 200′′C for 2 hours, is added. Then, the flask is heated to 100° C. to completely dissolve the calcium chloride.

(2) The temperature of the solution obtained in the step (1) is returned to room temperature, and then paraphenylenediamine (hereinafter abbreviated as “PPD”) is added. Then, the PPD is completely dissolved.

(3) While the temperature of the solution obtained in the step (2) is maintained at 20 ±2′C, terephthalic acid dichloride (hereinafter referred to as “TPC”) is added in ten separate portions at approximately 5-minute intervals.

(4) While the temperature of the solution obtained in the step (3) is maintained at 20±2° C., the solution is matured for 1 hour, and is then stirred under reduced pressure for 30 minutes to eliminate air bubbles, so that the solution of the PPTA is obtained.

(5) The obtained solution of the PPTA is stirred at 40° C. for 1 hour at 300 rpm to precipitate PPTA particles (aramid filler).

The average particle diameter (D50 [volume-based]) of the aramid filler is not limited to any particular value, but is preferably within a range of 0.01 μm to 20 μm. If the aramid filler has an average particle diameter (D50 [volume-based]) of less than 0.01 μm, the aramid filler will fill the pores of the nonaqueous electrolyte secondary battery porous layer and may decrease the ion permeability of the battery. If the aramid filler has an average particle diameter (D50 [volume-based]) of more than 20 μm, the aramid filler will be unevenly present in the nonaqueous electrolyte secondary battery porous layer and may thereby decrease the heat resistance of the nonaqueous electrolyte secondary battery porous layer. The average particle diameter (D50 [volume-based]) of the aramid filler can be measured with use of a laser diffraction particle size analyzer (SALD-2200) available from Shimadzu Corporation.

The aramid filler may have any shape. The aramid filler may be, for example, a particulate filler. Example shapes of particles of the aramid filler encompass a spherical shape, an elliptical shape, a plate shape, a bar shape, an indefinite irregular shape, and shapes such as a peanut-like shape and/or a tetrapod-like shape which are formed by bonding of particles having a spherical shape or a pillar shape. In view of prevention of the occurrence of a short circuit in the battery, the aramid filler is made of preferably (i) irregularly shaped particles and/or (ii) primary particles that have not agglomerated. Further, in view of ion permeation, the aramid filler is made of preferably particles having a shape with any of protrusions, hollows, constrictions, bumps and bulges, which (i) make the particles unable to easily form close packing and (ii) also make it easy to form a gap between particles. Examples of such a shape encompass: an indefinite irregular shape such as a dendritic shape, a coral-like shape, or a tuft-like shape; and a shape such as a peanut-like shape and a tetrapod-like shape which are formed by bonding of individual particles.

The aspect ratio of the aramid filler is not limited to any particular value, but is preferably within a range of 1 to 100. If the aramid filler has an aspect ratio of more than 100, the aramid filler particles will be separated from one another by a small gap, which may increase the air permeability of the nonaqueous electrolyte secondary battery porous layer. The aspect ratio of the aramid filler can be calculated by, for example, the following method: First, a solution containing the aramid filler is dried on a glass plate. Then, SEM surface observation (observation of a reflected electron image) is carried out at an acceleration voltage of 0.5 kV with use of a field emission scanning electron microscope JSM-7600F available from JEOL Ltd. so that an electron micrograph (SEM image) with a magnification of 10000 is obtained. Next, the SEM image obtained is imported into a computer. Then, individual aramid filler particles are separated and detected with luminance as a threshold with use of free image analysis software IMAGEJ (provided by the National Institutes of Health [NIH]). To calculate the area of the aramid filler, a luminance increasing process is carried out with respect to an inner portion of the region of each aramid filler particle detected which inner portion has low luminance. The long-axis diameter and the short-axis diameter of each filler particle detected are measured. Specifically, the shape of each particle of the aramid filler is approximated to an elliptical shape. Further, the long-axis diameter of the elliptical shape and the short-axis diameter of the elliptical shape are calculated. Then, the value obtained by dividing the long-axis diameter of the elliptical shape by the short-axis diameter of the elliptical shape is defined as the aspect ratio of each particle of the filler. The average value of the respective aspect ratios of the filler particles is used as the aspect ratio of the aramid filler.

The porous layer in accordance with an aspect of the present invention may contain the aramid filler in any amount. However, for better air permeability of the porous layer, the content is preferably not less than 10% by weight, more preferably not less than 30% by weight, even more preferably not less than 50% by weight, even more preferably not less than 90% by weight, relative to the total weight of the porous layer. Further, the content of the aramid filler in the porous layer is preferably not more than 99.5% by weight, more preferably not more than 98% by weight, relative to the total weight of the porous layer. The porous layer containing the aramid filler in an amount of not less than 10% by weight facilitates forming voids in the porous layer, thereby increasing the air permeability. The porous layer containing the aramid filler in an amount of not more than 99.5% by weight prevents aramid filler particles from agglomerating in the composition as a material of the porous layer, with the result of better coating material dispersibility.

The composition in accordance with an aspect of the present invention may contain, in addition to the aramid filler, another component(s) such as resin and a filler other than aramid filler.

The resin may function as a binder for binding (i) particles of the aramid filler to one another, (ii) the aramid filler to an electrode, and (iii) the aramid filler to a porous film (porous base material).

The resin is preferably insoluble in the electrolyte of the battery and electrochemically stable under the use condition of the battery. Examples of the resin encompass: polyolefins such as polyethylene, polypropylene, polybutene, and an ethylene-propylene copolymer; fluorine-containing resins such as polyvinylidene fluoride (PVDF), polytetrafluoroethylene, a vinylidene fluoride-hexafluoropropylene copolymer, a tetrafluoroethylene-hexafluoropropylene copolymer, a tetrafluoroethylene-perfluoroalkyl vinyl ether copolymer, a vinylidene fluoride-tetrafluoroethylene copolymer, a vinylidene fluoride-trifluoro ethylene copolymer, a vinylidene fluoride-trichloroethylene copolymer, a vinylidene fluoride-vinyl fluoride copolymer, a vinylidene fluoride-hexafluoropropylene-tetrafluoroethylene copolymer, and an ethylene-tetrafluoroethylene copolymer; a fluorine-containing rubber having a glass transition temperature of equal to or less than 23° C., among the fluorine-containing resins; aromatic polyamides; wholly aromatic polyamides (aramid resin); rubbers such as a styrene-butadiene copolymer and a hydride thereof, a methacrylic acid ester copolymer, an acrylonitrile-acrylic acid ester copolymer, a styrene-acrylic acid ester copolymer, ethylene propylene rubber, and polyvinyl acetate; resins with a melting point or glass transition temperature of not lower than 180° C. such as polyphenylene ether, polysulfone, polyether sulfone, polyphenylene sulfide, polyetherimide, polyamide imide, polyether amide, and polyester; and water-soluble polymers such as polyvinyl alcohol, polyethylene glycol, cellulose ether, sodium alginate, polyacrylic acid, polyacrylamide, and polymethacrylic acid.

Among the above resins, a polyolefin, a fluorine-containing resin, an aromatic polyamide, and a water-soluble polymer are preferable. In a case where the nonaqueous electrolyte secondary battery porous layer is to be so disposed as to face a positive electrode, a fluorine-containing resin is more preferable, and a polyvinylidene fluoride-based resin is particularly preferable. Examples of the polyvinylidene fluoride-based resin encompass: a copolymer of vinylidene fluoride and at least one monomer selected from the group consisting of hexafluoropropylene, tetrafluoroethylene, trifluoroethylene, trichloroethylene, and vinyl fluoride; and a homopolymer of vinylidene fluoride (that is, polyvinylidene fluoride). This is because such a resin makes it easy to maintain various properties such as a rate characteristic and a resistance characteristic (solution resistance) even in a case where the nonaqueous electrolyte secondary battery suffers acidic deterioration during operation of the nonaqueous electrolyte secondary battery.

The content of the above resin in the composition is not limited to any particular value, but is within a range of, for example, 0.01% by weight to 10% by weight, 0.01% by weight to 5% by weight, 0.01% by weight to 2% by weight, or 0.01% by weight to 1% by weight of the content of the aramid filler in the above composition.

The above filler other than aramid filler may be organic powder, inorganic powder, or a mixture thereof.

Examples of the organic powder encompass powders made of organic matter such as: (i) a homopolymer of a monomer such as styrene, vinyl ketone, acrylonitrile, methyl methacrylate, ethyl methacrylate, glycidyl methacrylate, glycidyl acrylate, or methyl acrylate or (ii) a copolymer of two or more of such monomers; fluorine-based resins such as polytetrafluoroethylene, ethylene tetrafluoride-propylene hexafluoride copolymer, ethylene tetrafluoride-ethylene copolymer, and polyvinylidene fluoride; melamine resin; urea resin; polyolefin; and polymethacrylate. The filler can be made of one of these organic powders, or can be made of two or more of these organic powders mixed. Among these organic powders, a polytetrafluoroethylene powder is preferable in view of chemical stability.

Examples of the inorganic powder encompass powders made of inorganic matters such as metal oxide, metal nitride, metal carbide, metal hydroxide, carbonate, and sulfate. Specific examples of the inorganic powder encompass powders made of inorganic matters such as alumina, silica, titanium dioxide, aluminum hydroxide, and calcium carbonate. The filler can be made of one of these inorganic powders, or can be made of two or more of these inorganic powders mixed. Among these inorganic powders, an alumina powder is preferable in view of chemical stability.

Applying the composition in accordance with an aspect of the present invention to an electrode or a base material (for example, a polyolefin porous film) for a nonaqueous electrolyte secondary battery allows a nonaqueous electrolyte secondary battery porous layer to be formed on the electrode or the base material. The composition may be applied by any method. Examples of the method encompass a doctor blade method.

The following description will discuss various physical properties of the composition in accordance with an aspect of the present invention.

For better storage property of the composition, the viscosity at the shear rate of 0.1 [sec⁻¹] is preferably not less than 0.1 [Pa·sec], more preferably not less than 0.15 [Pa·sec], even more preferably not less than 0.2 [Pa·sec].

If the viscosity of the composition at a low shear rate is excessively high, the following problem, for example, can be caused: The composition cannot be sent during a process of producing a nonaqueous electrolyte secondary battery porous layer which process repeats starting and stopping the operation. Thus, the viscosity of the composition at a low shear rate has a preferable range for the production process.

In view of the above, the viscosity of the composition at the shear rate of 0.1 [sec⁻¹] is preferably not more than 1000 [Pa·sec], more preferably not more than 100 [Pa·sec].

For the composition to be sent easily, the viscosity of the composition at the shear rate of 100 [sec⁻¹] is preferably not more than 2 [Pa·sec], more preferably not more than 1.5 [Pa·sec]. To prevent the aramid filler from precipitating easily, the viscosity of the composition at the shear rate of 100 [sec⁻¹] is preferably not less than 0.05 [Pa·sec], more preferably not less than 0.1 [Pa·sec].

For better handleability of the composition during the step of applying the composition to a base material or the like, the viscosity of the composition at the shear rate of 10000 [sec⁻¹] is preferably not more than 0.2 [Pa·sec], more preferably not more than 0.15 [Pa·sec]. The viscosity of the composition at the shear rate of 10000 [sec⁻¹] has no particularly lower limit. The lower limit is, for example, not less than 0.01 [Pa·sec].

For the composition to be stored, sent, and applied suitably, 1≤a/b≤600 is preferably satisfied, and the formula (1) below is more preferably satisfied,

1≤a/b≤150 (1),

where a represents the viscosity [Pa·sec] that the composition has when the composition is sheared at the shear rate of 0.1 [sec⁻¹], and b represents the viscosity [Pa·sec] that the composition has when the composition is sheared at the shear rate of 100 [sec⁻¹].

For the composition to be stored, sent, and applied suitably, 2≤a/c≤40000 is preferably satisfied, and the formula (2) below is more preferably satisfied,

2≤a/c≤2000 (2),

where a represents the viscosity [Pa·sec] that the composition has when the composition is sheared at the shear rate of 0.1 [sec⁻¹], and c represents the viscosity [Pa·sec] that the composition has when the composition is sheared at the shear rate of 10000 [sec⁻¹].

For the composition to be sent and applied suitably, the formula (3) below is preferably satisfied,

0.01≤|A−B|≤200 (3),

where A represents the viscosity [Pa·sec] that the composition has with the shear rate being 0.1 [sec⁻¹] at the start of an increase of the shear rate in a case where the composition is sheared while the shear rate is being increased from 0.1 [sec⁻¹] to 10000 [sec⁻¹] and is then sheared while the shear rate is being decreased from 10000 [sec⁻¹] to 0.1 [sec⁻¹], and B represents the viscosity [Pa·sec] that the composition has with the shear rate being 0.1 [sec⁻¹] at the end of a decrease of the shear rate in the above case.

A hysteresis (in other words, the value of |A−B|) of less than 0.01 will mean that the composition is not easily subjected to a shear history. In a case where, for instance, the composition has started to be sent with the shearing device out of operation, the viscosity of the composition will not easily be decreased and will likely cause clogging. A hysteresis of more than 200 Pa·sec will mean that the composition is easily subjected to a shear history. In a case where, for instance, the composition has been sheared at a high shear rate and then been applied to a base material or the like, the composition may run to be lost, which may make it impossible to apply the composition to a base material or the like in a desired amount.

The composition in accordance with an aspect of the present invention is usable to prepare a nonaqueous electrolyte secondary battery porous layer. The nonaqueous electrolyte secondary battery porous layer is usable as a nonaqueous electrolyte secondary battery separator or as a component of a nonaqueous electrolyte secondary battery separator.

The method for preparing the nonaqueous electrolyte secondary battery porous layer is not limited to any particular one, but is, for example, a method of applying the composition in accordance with an aspect of the present invention to a base material and then removing the organic solvent from the applied composition by drying the composition.

The base material is, for example, the above-mentioned polyolefin porous film or a below-described electrode (that is, a positive electrode or a negative electrode).

Example methods for coating the base material with the composition encompass publicly known coating methods such as a knife coater method, a blade coater method, a bar coater method, a gravure coater method, and a die coater method.

The organic solvent is typically removed by a drying method. The organic solvent may be replaced with a low-boiling-point solvent before the drying operation. Examples of the drying method encompass natural drying, air-blow drying, heat drying, and drying under reduced pressure. The organic solvent can, however, be removed by any method that allows the organic solvent to be removed sufficiently. Examples of the low-boiling-point solvent encompass water, alcohol, and acetone.

The nonaqueous electrolyte secondary battery porous layer contains a large number of pores connected to one another, and thus allows a gas or a liquid to pass therethrough from one surface to the other.

The nonaqueous electrolyte secondary battery porous layer has a thickness within a range of preferably 0.5 μm to 15 μm, more preferably 2 μm to 10 μm. This thickness intends to mean the thickness of a nonaqueous electrolyte secondary battery porous layer on one surface of a nonaqueous electrolyte secondary battery separator described later. In a case where the nonaqueous electrolyte secondary battery porous layer has a thickness of not less than 0.5 μm, the nonaqueous electrolyte secondary battery porous layer can sufficiently prevent internal short circuiting of the battery and can retain a sufficient amount of the electrolyte. In a case where the nonaqueous electrolyte secondary battery porous layer has a thickness of not more than 15 μm, the nonaqueous electrolyte secondary battery porous layer prevents the resistance to ion permeation from increasing, and can also prevent (i) the positive electrode from being degraded and (ii) the rate characteristic and the cycle characteristic from being decreased as a result of repeated charge-and-discharge cycles. Further, the nonaqueous electrolyte secondary battery porous layer does not increase the distance between the positive electrode and the negative electrode to a large extent, thereby preventing the nonaqueous electrolyte secondary battery from being large-sized.

The nonaqueous electrolyte secondary battery porous layer has a weight per unit area within a range of preferably 0.5 g/m² to 20 g/m², more preferably 0.5 g/m² to 10 g/m², even more preferably 0.5 g/m² to 7 g/m², in terms of the solid content in view of adhesiveness to an electrode and ion permeability. This weight per unit area intends to mean the weight per unit area of a nonaqueous electrolyte secondary battery porous layer on one surface of a nonaqueous electrolyte secondary battery separator described later.

[2. Nonaqueous Electrolyte Secondary Battery Separator]

The nonaqueous electrolyte secondary battery separator in accordance with an aspect of the present invention includes (i) a polyolefin porous film and (ii) a nonaqueous electrolyte secondary battery porous layer (which is made of the composition in accordance with an aspect of the present invention) on one surface or both surfaces of the polyolefin porous film.

<Polyolefin Porous Film>

The polyolefin porous film can be a base material for a nonaqueous electrolyte secondary battery separator. The polyolefin porous film contains a polyolefin-based resin as a main component. The polyolefin porous film has therein many pores, connected to one another, so that a gas and/or a liquid can pass through the polyolefin porous film from one surface to the other surface. The polyolefin porous film may include a single layer or a plurality of layers provided so as to form a laminate.

The expression that the polyolefin porous film “contains a polyolefin-based resin as a main component” means that a polyolefin-based resin accounts for not less than 50% by volume, preferably not less than 90% by volume, and more preferably not less than 95% by volume, of the entire polyolefin porous film. The polyolefin-based resin more preferably contains a high molecular weight component having a weight-average molecular weight of 3×10⁵ to 15×10⁶. In particular, the polyolefin-based resin more preferably contains a high molecular weight component having a weight-average molecular weight of not less than 1,000,000 because such a polyolefin-based resin allows a nonaqueous electrolyte secondary battery separator to have a higher strength.

Examples of the polyolefin-based resin which is a main component of the polyolefin porous film include, but are not particularly limited to, homopolymers (for example, polyethylene, polypropylene, and polybutene) and copolymers (for example, ethylene-propylene copolymer), which are produced through (co)polymerization of a monomer such as ethylene, propylene, 1-butene, 4-methyl-l-pentene, and 1-hexene (which are thermoplastic resins). Among the above examples, polyethylene is preferable as it is capable of preventing (shutting down) a flow of an excessively large electric current at a lower temperature. Examples of the polyethylene include a low-density polyethylene, a high-density polyethylene, a linear polyethylene (an ethylene-a-olefin copolymer), and an ultra-high molecular weight polyethylene having a weight-average molecular weight of not less than 1,000,000. Among these examples, the polyethylene is more preferably a high molecular weight polyethylene having a weight-average molecular weight of 300,000 to 1,000,000 or an ultra-high molecular weight polyethylene having a weight-average molecular weight of not less than 1,000,000. Concrete examples of the polyolefin-based resin encompass a polyolefin-based resin made of a mixture of (i) a polyolefin having a weight-average molecular weight of not less than 1,000,000 and (ii) a low molecular weight polyolefin having a weight-average molecular weight of not more than 10,000.

The thickness of the polyolefin porous film is selected as appropriate in view of the thickness of the nonaqueous electrolyte secondary battery separator. The thickness is within a range of preferably 4 μm to 40 μm, more preferably 5 μm to 20 μm, for example.

The polyolefin porous film has a thickness of preferably not less than 4 μm because such a polyolefin porous film can sufficiently prevent internal short circuiting that may occur due to, for example, breakage of the nonaqueous electrolyte secondary battery. On the other hand, the polyolefin porous film preferably has a film thickness of not more than 40 μm. This is because such a film thickness makes it possible to (i) prevent the resistance to lithium ion permeation from increasing all over the nonaqueous electrolyte secondary battery separator, (ii) prevent the positive electrode from being degraded and also to prevent the rate characteristic and the cycle characteristic from being decreased as a result of repeated charge-and-discharge cycles, in a nonaqueous electrolyte secondary battery including the nonaqueous electrolyte secondary battery separator, and (iii) prevent an increase in the size of the battery in a case where the distance between the positive electrode and the negative electrode increases.

The polyolefin porous film has a weight per unit area selected as appropriate in view of strength, film thickness, weight, and handleability of the nonaqueous electrolyte secondary battery separator including the polyolefin porous film. The polyolefin porous film has a weight per unit area typically within a range of preferably 4 g/m² to 20 g/m², more preferably 5 g/m² to 12 g/m², so as to allow the battery to have a higher weight energy density and a higher volume energy density.

The polyolefin porous film has a porosity of preferably 20% by volume to 80% by volume and more preferably 30% by volume to 75% by volume, so as to (i) retain a larger amount of an electrolyte solution and (ii) obtain the function of reliably preventing (shutting down) a flow of an excessively large electric current at a lower temperature. The polyolefin porous film preferably has a porosity of not less than 20% by volume. This is because such a porosity makes it possible to restrict resistance of the polyolefin porous film to ion permeation. To increase the mechanical strength of the polyolefin porous film, the porosity of the polyolefin porous film is preferably not more than 80% by volume.

The polyolefin porous film has a pore size of preferably not more than 0.3 μm, and more preferably not more than 0.14 μm, so that the nonaqueous electrolyte secondary battery separator can have sufficient ion permeability and prevent particles from entering the positive electrode and the negative electrode.

The nonaqueous electrolyte secondary battery separator may include, in addition to the polyolefin porous film and the nonaqueous electrolyte secondary battery porous layer (which is made of the composition in accordance with an aspect of the present invention), another porous layer(s) as necessary. Examples of such another porous layer encompass a heat-resistant layer, an adhesive layer, and a protective layer.

<Method for Producing Polyolefin Porous Film>

The method for producing a polyolefin porous film is not limited to any particular one, and can be, for example, a method including the steps of first adding a pore forming agent to a resin such as a polyolefin to form a film (forming the resin into a film), and then removing the pore forming agent with use of an appropriate solvent.

Specifically, in a case where, for example, the polyolefin porous film is made of a polyolefin resin containing an ultra-high molecular weight polyethylene and a low molecular weight polyolefin which has a weight-average molecular weight of not more than 10,000, the polyolefin porous film is preferably produced by, in view of production costs, a method including the steps below.

An Example Method Includes

(1) kneading 100 parts by weight of the ultra-high molecular weight polyethylene, 5 parts by weight to 200 parts by weight of the low molecular weight polyolefin having a weight-average molecular weight of not more than 10,000, and 100 parts by weight to 400 parts by weight of a pore forming agent, so that a polyolefin resin composition is obtained;

(2) forming the polyolefin resin composition into a sheet by rolling;

(3) removing the pore forming agent from the rolled sheet having been obtained by rolling in the step (2);

(4) stretching the rolled sheet from which the pore forming agent has been removed in the step (3); and

(5) heat fixing the rolled sheet having been stretched in the step (4) at a temperature of not lower than 100° C. and not higher than 150° C., so that a porous film is obtained.

An Alternative Method Includes
(1) kneading 100 parts by weight of the ultra-high molecular weight polyethylene, 5 parts by weight to 200 parts by weight of the low molecular weight polyolefin having a weight-average molecular weight of not more than 10,000, and 100 parts by weight to 400 parts by weight of a pore forming agent, so that a polyolefin resin composition is obtained;
(2) forming the polyolefin resin composition into a sheet by rolling;
(3′) stretching the rolled sheet obtained in the step (2);
(4′) removing the pore forming agent from the rolled sheet having been stretched in the step (3′); and
(5′) heat fixing the rolled sheet obtained in the step (4′) at a heat-fixation temperature of not lower than 100° C. and not higher than 150′'C, so that a porous film is obtained.

Examples of the pore forming agent encompass a plasticizer and a bulking agent which is made of an inorganic material.

Examples of the bulking agent which is made of an inorganic material include, but are not particularly limited to, an inorganic filler. Examples of the plasticizing agent include, but are not particularly limited to, a low molecular weight hydrocarbon such as liquid paraffin.

<Method for Producing Nonaqueous Electrolyte Secondary Battery Separator>

The method for producing a nonaqueous electrolyte secondary battery separator is not limited to any particular one, but is, for example, a method of applying the composition in accordance with an aspect of the present invention to a polyolefin porous film and then removing the organic solvent from the applied composition by drying the composition.

[3. Nonaqueous Electrolyte Secondary Battery Member and Nonaqueous Electrolyte Secondary Battery]

The nonaqueous electrolyte secondary battery member in accordance with the present embodiment includes (i) a positive electrode, (ii) a nonaqueous electrolyte secondary battery porous layer in accordance with an aspect of the present invention or a nonaqueous electrolyte secondary battery separator in accordance with an aspect of the present invention, and (iii) a negative electrode that are arranged in this order.

The nonaqueous electrolyte secondary battery in accordance with the present embodiment includes a nonaqueous electrolyte secondary battery porous layer in accordance with an aspect of the present invention or a nonaqueous electrolyte secondary battery separator in accordance with an aspect of the present invention.

The nonaqueous electrolyte secondary battery in accordance with an aspect of the present invention is typically arranged such that a battery element is enclosed in an exterior member, the battery element including (i) a structure in which the negative electrode and the positive electrode face each other via a nonaqueous electrolyte secondary battery porous layer in accordance with an aspect of the present invention or a nonaqueous electrolyte secondary battery separator in accordance with an aspect of the present invention and (ii) an electrolyte with which the structure is impregnated. The nonaqueous electrolyte secondary battery in accordance with an aspect of the present invention is preferably a lithium-ion secondary battery. Note that the doping means occlusion, support, adsorption, or insertion, and means a phenomenon in which lithium ions enter an active material of an electrode (e.g., a positive electrode).

<Positive Electrode>

The positive electrode is not limited to any particular one, provided that the positive electrode is one that is typically used as the positive electrode of a nonaqueous electrolyte secondary battery. Examples of the positive electrode encompass a positive electrode sheet having a structure in which an active material layer containing a positive electrode active material and a binder resin is formed on a current collector. The active material layer may further contain an electrically conductive agent.

The positive electrode active material is, for example, a material capable of being doped and dedoped with lithium ions. Specific examples of such a material include a lithium complex oxide containing at least one transition metal such as V, Mn, Fe, Co, or Ni. Among such lithium complex oxides, (i) a lithium complex oxide having an α-NaFeO₂ structure such as lithium nickelate and lithium cobaltate and (ii) a lithium complex oxide having a spinel structure such as lithium manganese spinel are preferable because such lithium complex oxides have a high average discharge potential. The lithium complex oxide may further contain any of various metallic elements, and is further preferably complex lithium nickelate.

Further, in a case where the complex lithium nickelate contains at least one metal element selected from the group consisting of Ti, Zr, Ce, Y, V, Cr, Mn, Fe, Co, Cu, Ag, Mg, Al, Ga, In, and Sn at a proportion of 0.1 mol % to 20 mol % with respect to the sum of the number of moles of Ni and the number of moles of the at least one metal element, the complex lithium nickelate allows for an excellent cycle characteristic when used in a high-capacity battery. Among such active materials, an active material which contains Al or Mn and in which a ratio of Ni is 85% or more, and more preferably 90% or more is particularly preferable. This is because such an active material allows an excellent cycle characteristic for use in a high-capacity battery including a positive electrode containing the active material.

Examples of the electrically conductive material include carbonaceous materials such as natural graphite, artificial graphite, cokes, carbon black, pyrolytic carbons, carbon fiber, and a fired product of an organic polymer compound. It is possible to use (i) only one kind of the above electrically conductive agents or (ii) two or more kinds of the above electrically conductive agents in combination, for example, a mixture of artificial graphite and carbon black.

Examples of the binding agent encompass: polyvinylidene fluoride, a copolymer of vinylidene fluoride, polytetrafluoroethylene, a vinylidene fluoride-hexafluoropropylene copolymer, a tetrafluoroethylene-hexafluoropropylene copolymer, a tetrafluoroethylene-perfluoroalkyl vinyl ether copolymer, an ethylene-tetrafluoroethylene copolymer, a vinylidene fluoride-tetrafluoroethylene copolymer, a vinylidene fluoride-trifluoroethylene copolymer, a vinylidene fluoride-trichloroethylene copolymer, a vinylidene fluoride-vinyl fluoride copolymer, a vinylidene fluoride-hexaflu oropropylene-tetrafluoroethylene copolymer, thermoplastic resins (such as a thermoplastic polyimide, polyethylene, and polypropylene); acrylic resin; and styrene-butadiene-rubber. Note that the binding agent also functions as a thickener.

Examples of a method for preparing a positive electrode mix as a positive electrode material encompass: a method in which pressure is applied to the positive electrode active material, the electrically conductive agent, and the binding agent on a positive electrode current collector; and a method in which an appropriate organic solvent is used so that the positive electrode active material, the electrically conductive material, and the binding agent will be in a paste form.

Examples of the positive electrode current collector include electric conductors such as Al, Ni, and stainless steel. Among these, Al is preferable as it is easy to process into a thin film and less expensive.

The positive electrode sheet may be produced, that is, the positive electrode mix may be supported by the positive electrode current collector, by for example, a method in which pressure is applied to the positive electrode active material, the electrically conductive agent, and the binding agent on the positive electrode current collector to form a positive electrode mix thereon or a method in which (i) an appropriate organic solvent is used so that the positive electrode active material, the electrically conductive agent, and the binding agent will be in a paste form to provide a positive electrode mix, (ii) the positive electrode mix is applied to the positive electrode current collector, (iii) the applied positive electrode mix is dried so that a sheet-shaped positive electrode mix is prepared, and (iv) then pressure is applied to the sheet-shaped positive electrode mix so that the sheet-shaped positive electrode mix is firmly fixed to the positive electrode current collector.

<Negative Electrode>

The negative electrode is not limited to any particular one, provided that the negative electrode is one that is typically used as the negative electrode of a nonaqueous electrolyte secondary battery. Examples of the negative electrode encompass a negative electrode sheet having a structure in which an active material layer containing a negative electrode active material and a binder resin is formed on a current collector. The active material layer may further contain an electrically conductive agent.

The negative electrode active material is, for example, (i) a material capable of being doped and dedoped with lithium ions, (ii) lithium metal, and (iii) lithium alloy. Specific examples of the material encompass: carbonaceous materials such as natural graphite, artificial graphite, cokes, carbon black, pyrolytic carbons, carbon fiber, and a fired product of an organic polymer compound; chalcogen compounds such as an oxide and a sulfide that are doped with and dedoped of lithium ions at an electric potential lower than that for the positive electrode; metals such as aluminum (Al), lead (Pb), tin (Sn), bismuth (Bi), or silicon (Si), each of which is alloyed with alkali metal; cubic intermetallic compounds (AlSb, Mg₂Si, and NiSi₂) having lattice spaces in which alkali metals can be provided; and lithium nitrogen compounds (Li₃-xMₓN (where M represents a transition metal)). Among the above negative electrode active materials, a carbonaceous material that contains, as a main component, a graphite material such as natural graphite or artificial graphite is preferable. This is because such a carbonaceous material is high in potential evenness, and a great energy density can be obtained in a case where the carbonaceous material, which is low in average discharge potential, is combined with the positive electrode. The negative electrode active material may alternatively be a mixture of graphite and silicon, preferably containing Si at a proportion of not less than 5%, and more preferably not less than 10%, with respect to carbon (C) constituting the graphite.

The negative electrode mix as a negative electrode material may be prepared by, for example, a method in which pressure is applied to the negative electrode active material on a negative electrode current collector or a method in which an appropriate organic solvent is used so that the negative electrode active material will be in a paste form.

The negative electrode current collector is, for example, Cu, Ni, or stainless steel. Among these, Cu is preferable as it is not easily alloyed with lithium in the case of a lithium-ion secondary battery in particular and is easily processed into a thin film.

The negative electrode sheet may be produced, that is, the negative electrode mix may be supported by the negative electrode current collector, by for example, a method in which pressure is applied to the negative electrode active material on the negative electrode current collector to form a negative electrode mix thereon or a method in which (i) an appropriate organic solvent is used so that the negative electrode active material will be in a paste form to provide a negative electrode mix, (ii) the negative electrode mix is applied to the negative electrode current collector, (iii) the applied negative electrode mix is dried so that a sheet-shaped negative electrode mix is prepared, and (iv) then pressure is applied to the sheet-shaped negative electrode mix so that the sheet-shaped negative electrode mix is firmly fixed to the negative electrode current collector. The above paste preferably includes the above electrically conductive agent and the binding agent.

<Nonaqueous Electrolyte>

The nonaqueous electrolyte is a nonaqueous electrolyte generally used in a nonaqueous electrolyte secondary battery, and is not limited to any particular one. Examples of the nonaqueous electrolyte include a nonaqueous electrolyte prepared by dissolving a lithium salt in an organic solvent. Examples of the lithium salt encompass LiClO₄, LiPF₆, LiAsF₆, LiSbF₆, LiBF₄, LiCF₃SO₃, LiN(CF₃SO₂)₂, LiC(CF₃SO₂)₃, Li₂B₁₀Cl₁₀, lower aliphatic carboxylic acid lithium salt, and LiAlCl₄. It is possible to use only one kind of the above lithium salts or two or more kinds of the above lithium salts in combination. It is preferable to use, among the above lithium salts, at least one fluorine-containing lithium salt selected from the group consisting of LiPF₆, LiAsF₆, LiSbF₆, LiBF₄, LiCF₃SO₃, LiN(CF₃SO₂)₂, and LiC(CF₃SO₂)₃.

Specific examples of the organic solvent in the nonaqueous electrolyte include: carbonates such as ethylene carbonate, propylene carbonate, dimethyl carbonate, diethyl carbonate, ethyl methyl carbonate, 4-trifluoromethyl-1,3-dioxolane-2-on, and 1,2-di(methoxy carbonyloxy)ethane; ethers such as 1,2-dimethoxyethane, 1,3-dimethoxypropane, pentafluoropropyl methyl ether, 2,2,3,3-tetrafluoropropyl difluoro methyl ether, tetrahydrofuran, and 2-methyl tetrahydrofuran; esters such as methyl formate, methyl acetate, and γ-butyrolactone; nitriles such as acetonitrile and butyronitrile; amides such as N,N-dimethylformamide and N,N-dimethylacetamide; carbamates such as 3-methyl-2-oxazolidone; sulfur-containing compounds such as sulfolane, dimethyl sulfoxide, and 1,3-propane sultone; and fluorine-containing organic solvents each prepared by introducing a fluorine group into any of the organic solvents described above. It is possible to use only one kind of the above organic solvents or two or more kinds of the above organic solvents in combination. Among the above organic solvents, carbonates are preferable. A mixed solvent of a cyclic carbonate and an acyclic carbonate or a mixed solvent of a cyclic carbonate and an ether is more preferable. The mixed solvent of a cyclic carbonate and an acyclic carbonate is still more preferably a mixed solvent of ethylene carbonate, dimethyl carbonate, and ethyl methyl carbonate. This is because such a mixed solvent leads to a wider operating temperature range, and is not easily decomposed even in a case where a negative electrode active material is a graphite material such as natural graphite or artificial graphite.

<Method for Producing Nonaqueous Electrolyte Secondary Battery Member and Method for Producing Nonaqueous Electrolyte Secondary Battery>

A nonaqueous electrolyte secondary battery member in accordance with an aspect of the present invention can be produced by, for example, arranging (i) a positive electrode, (ii) a nonaqueous electrolyte secondary battery porous layer in accordance with an aspect of the present invention or a nonaqueous electrolyte secondary battery separator in accordance with an aspect of the present invention, and (iii) a negative electrode in this order.

A nonaqueous electrolyte secondary battery in accordance with an aspect of the present invention can be produced by, for example, (i) producing a nonaqueous electrolyte secondary battery member as described above, (ii) inserting the nonaqueous electrolyte secondary battery member into a container that will serve as a housing of a battery, (iii) filling the container with a nonaqueous electrolyte, and (iv) hermetically sealing the container while reducing pressure inside the container.

The nonaqueous electrolyte secondary battery is not particularly limited in shape and may have any shape such as the shape of a thin plate (sheet), a disk, a cylinder, or a prism such as a cuboid. The nonaqueous electrolyte secondary battery member and the nonaqueous electrolyte secondary battery may each be produced by any method, and may each be produced by a conventionally publicly known method.

### EXAMPLES

<1. Method for Evaluating Physical Properties>

The Examples involved measuring, by the methods below, physical properties of (i) a composition containing an organic solvent and an aramid filler dispersed in the organic solvent and (ii) a laminated porous film.

(1) Average Particle Diameter (D50 [volume-based]) (unit: μm):

The average particle diameter (D50 [volume-based]) was determined by the method (i) or (ii) below with use of a solution containing an aramid filler prepared through the example production below. Specifically, Example 1 used the method (ii) below, whereas Example 2 and Comparative Example 1 used the method (i) below.

(i) A solution containing an aramid filler prepared through the example production below was subjected to an ultrasonic method with use of DT-1202, available from Dispersion Technology, so that the average particle diameter was calculated.

(ii) A composition containing a small amount of an aramid filler and N-methyl-2-pyrrolidone were mixed with each other in a screw tube and subjected to ultrasonic waves for 2 minutes, so that a dispersion liquid was prepared. N-methyl-2-pyrrolidone was placed in a measuring quartz cell of a laser diffraction particle size analyzer (SALD-2200) available from Shimadzu Corporation. While the N-methyl-2-pyrrolidone was being stirred, base measurement was carried out. Then, the dispersion liquid was added with use of a pipette, and then the volume-based particle size distribution D50 of the aramid filler was measured.

(2) Viscosity

The viscosity that the composition had at a particular shear rate was measured with use of a rheometer (MCR301) available from AntonPaar.

Specifically, the viscosity of the composition was measured while the shear rate was being increased from 0.1 sec⁻¹ to 10000 sec⁻¹ at the rate of 20 seconds per digit over 100 seconds and was then measured while the shear rate was being decreased from 10000 sec⁻¹ to 0.1 sec⁻¹ at the rate of 20 seconds per digit over 100 seconds.

The measurement values obtained as the viscosity was measured while the shear rate was being increased were used as the viscosities that the composition had for different shear rates. Further, a calculation was made of the difference between (i) the viscosity that the composition had at the initial shear rate of 0.1 sec⁻¹ and (ii) the viscosity that the composition had at the shear rate of 0.1 sec⁻¹ after the shear rate was increased to 10000 sec⁻¹. The absolute value of the difference was used as a hysteresis.

(3) Air Permeability

The air permeability of the laminated porous film was measured in conformity with JIS P8117.

(4) Dimension Retaining Rate

A 5 cm×5 cm square piece was cut out of the laminated porous film. This film piece was marked with a 4 cm×4 cm square at the center. The film piece was sandwiched between two sheets of paper, and was heated in an oven with a temperature of 150° C. for 1 hour. Then, the film piece was taken out, and the size of the marked square was measured. The dimension retaining rate was calculated as follows:

Dimension retaining rate (%) for width direction (TD)=W2/W1×100,

where W1 represents the dimension of the mark in the width direction (TD) before the heating, and W2 represents the dimension of the mark in the width direction (TD) after the heating. The width direction (TD) refers to the direction orthogonal to the machine direction.

<2. Preparation of Aramid Polymerization Liquid>

Poly(paraphenylene terephthalamide) was prepared with use of a 500-mL separable flask having a stirring blade, a thermometer, a nitrogen incurrent canal, and a powder addition port.

First, the separable flask was dried sufficiently. Then, 440 g of N-methyl-2-pyrrolidone (NMP) was put into the separable flask. Further, 30.2 g of calcium chloride powder that had been vacuum-dried at 200° C. for 2 hours was put into the separable flask. The temperature inside the separable flask was raised to 100° C. so that the calcium chloride powder was completely dissolved in the N-methyl-2-pyrrolidone.

Next, the temperature inside the separable flask was returned to room temperature. Then, 13.2 g of paraphenylenediamine was put into the separable flask. The paraphenylenediamine was completely dissolved in the N-methyl-2-pyrrolidone, so that a mixed solution was obtained.

While the temperature of the mixed solution was maintained at 20±2° C., 23.47 g of terephthalic acid dichloride was added to the mixed solution in four separate portions at approximately 10-minute intervals.

After that, the mixed solution was matured for 1 hour with the temperature kept at 20±2° C. while the mixed solution was being stirred at 150 rpm, so that an aramid polymerization liquid was obtained.

<3. Preparation of Composition Containing Aramid Filler>

The aramid polymerization liquid obtained was stirred at 40° C. for 1 hour at 300 rpm for precipitation of poly(paraphenylene terephthalamide), so that a composition (1) was obtained that contained an aramid filler dispersed therein. Table 1 shows the results of evaluation of the composition (1).

<4. Preparation of Laminated Porous Film>

### Example 1

The composition (1) obtained was applied by a doctor blade method to a polyolefin porous film (with a thickness of 12 μm and a porosity of 41%) made of polyethylene, so that a laminated body was obtained. The laminated body obtained was let stand for 1 minute in air with a temperature of 50° C. and a relative humidity of 70%. After that, the laminated body was immersed in ion-exchange water and cleaned. The film cleaned was dried in an oven with a temperature of 70′C, so that a laminated porous film (1) was obtained that included a laminate of (i) a porous film containing an aramid filler and (ii) a polyolefin porous film.

The porous film (containing an aramid filler) of the laminated porous film (1) had a weight per unit area of 3.0 g/m². Table 1 shows the results of evaluation of the laminated porous film (1).

### Example 2

An example was conducted under conditions similar to those of Example 1 except that (i) Alumina C (available from Nippon Aerosil Co., Ltd.) was mixed with a solution containing the aramid filler prepared through the example production above in such a manner that poly(paraphenylene terephthalamide) and the Alumina C had a weight ratio of 1:1 and that (ii) NMP was added to the mixture so that the solid content was 3%. This produced a laminated porous film (2). The porous layer of the laminated porous film (2) had a weight per unit area of 1.5 g/m². Table 1 shows physical properties of the laminated porous film (2).

### Comparative Example 1

An example was conducted under conditions similar to those of Example 1 except that 21.6 g of calcium chloride powder was used for <2. Preparation of aramid polymerization liquid> and that the aramid polymerization liquid was stirred at 40° C. for 1 hour for <3. Preparation of composition containing aramid filler>. This produced a laminated porous film (3). The porous layer of the laminated porous film (3) had a weight per unit area of 2.0 g/m². Table 1 shows physical properties of the laminated porous film (3).

TABLE 1

| | Average | | | | | | | | |
|---|---|---|---|---|---|---|---|---|---|
| | particle | Viscosity [Pa · sec] | | | Thixotropy index | | | AP | Dimension |
| | diameter | 0.1 | 100 | 10000 | 0.1/ | 0.1/ | | (sec/ | retaining |
| | D50 (μm) | sec⁻¹ | sec⁻¹ | sec⁻¹ | 100 | 10000 | HY | 100 cm³ | rate (%) |
| Ex | 7.1 | 0.36 | 0.35 | 0.14 | 1.02 | 2.49 | 0.06 | 241 | 73 |
| 1 | | | | | | | | | |
| Ex | 8.5 | 2.89 | 0.68 | 0.20 | 4.25 | 14.45 | 0.07 | 279 | 93 |
| 2 | | | | | | | | | |
| CE | 8.3 | 4747 | 27.1 | 2.21 | 175 | 2148 | 3574 | 206 | 40 |
| 1 | | | | | | | | | |

″Ex″ stands for Example
″CE″ stands for Comparative Example
″Hy″ stands for Hysteresis
″AP″ stands for Air permeability

### INDUSTRIAL APPLICABILITY

The present invention is applicable to production of nonaqueous electrolyte secondary batteries (in particular, lithium-ion secondary batteries).

1. A composition, comprising:
an organic solvent; and
an aramid filler dispersed in the organic solvent.

2. The composition according to claim 1, wherein
a formula (1) below is satisfied,
1≤a/b≤150 (1),
where a represents a viscosity [Pa·sec] that the composition has when the composition is sheared at a shear rate of 0.1 [sec⁻¹], and b represents a viscosity [Pa·sec] that the composition has when the composition is sheared at a shear rate of 100 [sec⁻¹].

3. The composition according to claim 1, wherein a formula (2) below is satisfied,
2≤a/c≤2000 (2),
where a represents a viscosity [Pa·sec] that the composition has when the composition is sheared at a shear rate of 0.1 [sec⁻¹], and c represents a viscosity [Pa·sec] that the composition has when the composition is sheared at a shear rate of 10000 [sec⁻¹].

4. The composition according to claim 1, wherein
a formula (3) below is preferably satisfied,
0.01≤|A−B|≤200 (3),
where A represents a viscosity [Pa·sec] that the composition has with a shear rate being 0.1 [sec⁻¹] at a start of an increase of the shear rate in a case where the composition is sheared while the shear rate is being increased from 0.1 [sec⁻¹] to 10000 [sec⁻¹] and is then sheared while the shear rate is being decreased from 10000 [sec⁻¹] to 0.1 [sec⁻¹], and B represents a viscosity [Pa·sec] that the composition has with the shear rate being 0.1 [sec⁻¹] at an end of a decrease of the shear rate in the case.

5. A nonaqueous electrolyte secondary battery porous layer, comprising:
a composition according to claim 1.

6. A nonaqueous electrolyte secondary battery separator comprising:
a polyolefin porous film; and
a nonaqueous electrolyte secondary battery porous layer according to claim 5 on one surface or both surfaces of the polyolefin porous film.

7. A nonaqueous electrolyte secondary battery member, comprising:
a positive electrode;
a nonaqueous electrolyte secondary battery porous layer according to claim 5; and
a negative electrode,
the positive electrode, the nonaqueous electrolyte secondary battery porous layer, and the negative electrode being arranged in this order.

8. A nonaqueous electrolyte secondary battery, comprising:
a nonaqueous electrolyte secondary battery porous layer according to claim 5.

9. A nonaqueous electrolyte secondary battery member, comprising: a positive electrode; a nonaqueous electrolyte secondary battery separator according to claim 6; and a negative electrode, the positive electrode, the nonaqueous electrolyte secondary battery separator, and the negative electrode being arranged in this order.

10. A nonaqueous electrolyte secondary battery, comprising: a nonaqueous electrolyte secondary battery separator according to claim 6.
